(19) United States
(12) Patent Application Publication
(10) Pub. No.: US 2022/0358526 A1
(43) Pub. Date: Nov. 10, 2022

(54) COMPONENT INFORMATION MANAGEMENT DEVICE, COMPONENT INFORMATION MANAGEMENT METHOD, AND COMPONENT INFORMATION MANAGEMENT PROGRAM

(71) Applicant: Nippon Telegraph and Telephone Corporation, Tokyo (JP)

(72) Inventors: Masahiro YOKOTA, Musashino-shi, Tokyo (JP); Masatoshi NAMIKI, Musashino-shi, Tokyo (JP); Hiroto TAKECHI, Musashino-shi, Tokyo (JP); Katsuhiro ARAYA, Musashino-shi, Tokyo (JP); Masaaki INAMI, Musashino-shi, Tokyo (JP); Daisaku SHIMAZAKI, Musashino-shi, Tokyo (JP); Hideki MAEDA, Musashino-shi, Tokyo (JP)

(21) Appl. No.: 17/619,976

(22) PCT Filed: Jun. 21, 2019
(86) PCT No.: PCT/JP2019/024622

§ 371 Date: Dec. 16, 2021

(51) Int. Cl. G06Q 30/02

(52) U.S. Cl. CPC G06Q 30/0202; G06Q 30/0201

(57) ABSTRACT

A part information management device (10) includes: a part setting information acquirement unit (111) that acquires, as part setting information, information for identifying parts set in apparatuses; a market data acquirement unit (112) that acquires, for each of the parts, market data related to a part change of the part; a risk estimation unit (114) that estimates a risk of a silent change by a predetermined estimation algorithm with use of the market data, the risk of the silent change indicating that the part is changed; and a part information generation unit (113) that generates part information with the part setting information acquired for each of the parts and the estimated risk of the silent change corresponding to each other and stores the part information in a storage unit (13).

### TECHNICAL FIELD

The present invention relates to a part information management device, a part information management method, and a part information management program.

### BACKGROUND ART

In response to demands for availability of procurement of parts and cost reduction, a supply chain has recently been increasingly complicated and a case called a silent change has been found, where a part is delivered with a material thereof changed without notifying an orderer, i.e., a company (see Non-Patent Literature 1).

An article with the silent-changed part installed is likely to go on the market without being sufficiently designed and tested, which results in early deterioration of the article and occurrence of a failure. For example, in a network system as typified by a transmission system, a problem resulting from a silent change likewise occurs with a reduction in part cycle or the like. With a part constituting the network device changed without notice, a failure frequently occurs, significantly affecting a commercial service.

### CITATION LIST

### Non-Patent Literature

Non-Patent Literature 1: “Atarashii Seihin Anzen Kadai ‘Silent Change’ no Genjo (Current State of New Product Safety Problem ‘Silent Change’)”, [online], the Ministry of Economy, Trade and Industry, Product Safety Division, October, 2017, [Searched on Jun. 12, 2019], the Internet <URL: http://www.meti.go.jp/product safety/producer/point/pdf/silent_change.pdf>

### SUMMARY OF INVENTION

### Technical Problem

A variety of apparatuses are connected to a network system as typified by a transmission system but part information (inventory information) regarding the apparatuses is not disclosed to a carrier that provides a telecommunications service (i.e., a telecommunications firm, being hereinafter referred to as “communications carrier”) in some cases.

In a case where a part of an apparatus is changed, the part change is notifiable from a difference as long as inventory information regarding the apparatus is disclosed to the communications carrier. However, as for some apparatuses, only a vender (device vender) knows inventory information, failing to disclose a check method. In such a case, it is not possible for a communications carrier side to know a part change.

In a case where a part change (a silent change) of an apparatus that cannot be known on a communications carrier side is performed, if a malfunction attributed to the changed part occurs, it takes time to identify a cause and thus an increase in influence on a commercial service cannot be prevented. In addition, a problem would be continuously mixed due to a failure in ascertaining the cause.

The present invention has been made in view of such circumstances and an object thereof is to make it possible to estimate a risk of a silent change in advance.

### Means for Solving the Problem

A part information management device according to the present invention includes: a part setting information acquirement unit that acquires, as part setting information, information for identifying parts set in apparatuses; a market data acquirement unit that acquires, for each of the parts, market data related to a part change of the part; a risk estimation unit that estimates a risk of a silent change by a predetermined estimation algorithm with use of the market data, the risk of the silent change indicating that the part is changed; and a part information generation unit that generates part information with the part setting information acquired for each of the parts and the estimated risk of the silent change corresponding to each other and stores the part information in a storage unit.

### Effects of the Invention

According to the present invention, it is possible to estimate a risk of a silent change in advance.

### BRIEF DESCRIPTION OF DRAWINGS

FIG. 1 shows a typical method of managing information regarding parts set in devices.

FIG. 2 shows a method of managing information regarding parts set in devices according to the present embodiment.

FIG. 3 shows an overall configuration of a part information management system including a part information management device according to the present embodiment.

FIG. 4 is a functional block diagram showing a configuration of the part information management device according to the present embodiment.

FIG. 5 shows a data configuration example of part information according to the present embodiment.

FIG. 6 shows parts constituting a package to be installed in an apparatus according to the present embodiment.

FIG. 7 shows a maturity of a part in the market according to the present embodiment.

FIG. 8 shows a share of a part in the market according to the present embodiment.

FIG. 9 is a flowchart showing a flow of an estimation process of a risk of a silent change to be performed by the part information management device according to the present embodiment.

FIG. 10 is a flowchart showing a flow of an isolation process of a failure resulting from a silent change to be performed by the part information management device according to the present embodiment.

FIG. 11 is a hardware configuration diagram showing an example of a computer that implements a function of the part information management device according to the present embodiment.

### DESCRIPTION OF EMBODIMENT

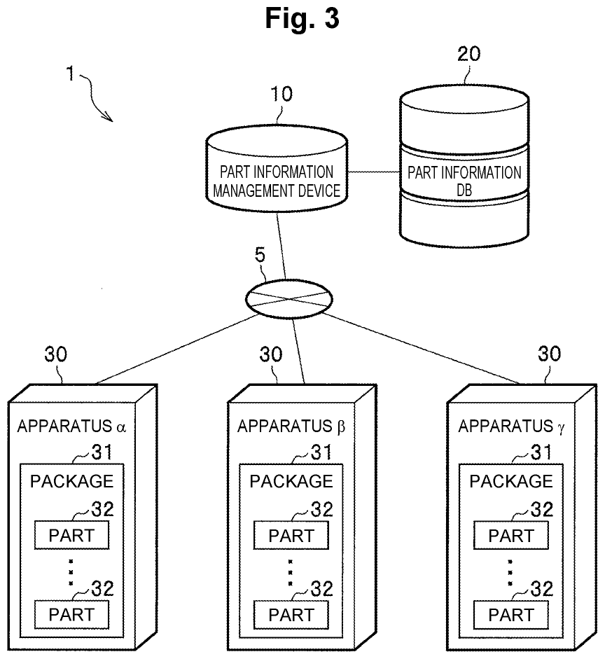

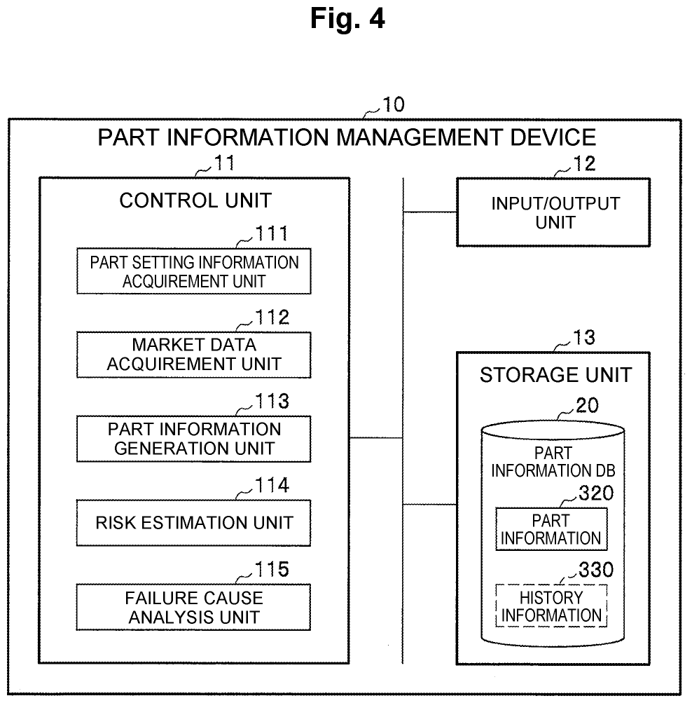

Next, description will be made on an embodiment for implementing the present invention (hereinafter, referred to as “the present embodiment”). First, description will be made on an outline of a system including a part information management device 10 according to the present embodiment (see FIG. 3 and FIG. 4 described later).

<Outline>

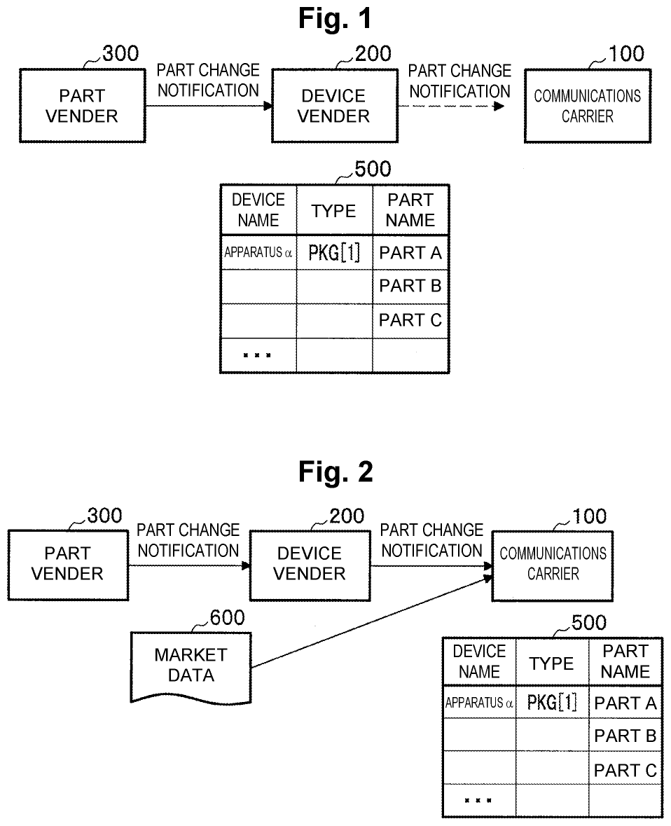

FIG. 1 shows a typical method of managing information regarding parts set in devices.

As shown in FIG. 1, a device vender 200 typically manages, as part setting information 500, information indicating what types of packages are installed in devices and information for identifying parts used in the packages. It should be noted that the part setting information 500 is information including, for example, a device name, a type, and a part name as shown in FIG. 1. In this state, for example, a difficulty for a part vender 300 to obtain a raw material, a demand for cost cutting, or the like sometimes requires changing a part. In a case where the part is changed, the device vender 200 can know the change in the part on the basis of a part change notification from the part vender 300. However, a communications carrier 100 receives no part change notification from the device vender 200 in some cases. Further, even though different device venders 200 use the same part manufactured by the same part vender 300, a communications carrier 100 side cannot know such information. Thus, even if the part of one of the device venders 200 is changed and a failure occurs in the changed part, the communications carrier 100 side cannot take action in advance for a device of the other device vender 200 including the changed part in which a failure is highly likely to occur.

FIG. 2 shows a method of managing information regarding parts set in devices according to the present embodiment.

In a system according to the present embodiment, information regarding the parts of the devices (information including the part setting information 500) is also managed by the communications carrier 100. In addition, the communications carrier 100 receives a part change notification from the device vender 200 or the part vender 300 and acquires market data 600 (a market maturity, a share in the market, part decline information indicating stoppage of manufacturing of a part, etc.), thereby estimating a risk of a silent change resulting from a part change.

The above manner allows information to be shared on a part basis between individual devices of the same device vender and devices of different device venders, enabling sharing, on a part basis, a risk of occurrence of a problem or an influence of a failure resulting from a silent change. In addition, estimation of a risk of a silent change resulting from a part change in advance enables promptly isolating, when a failure occurs, whether or not it is a problem resulting from a silent change.

### Present Embodiment

Next, description will be made on a part information management system 1 including the part information management device 10.

FIG. 3 shows an overall configuration of the part information management system 1 including the part information management device 10 according to the present embodiment.

The part information management system 1 includes the part information management device 10, a part information database (DB) 20, and one or more apparatuses 30. The part information management device 10 and each of the apparatuses 30 are connected to each other through, for example, a network (NW) 5. The part information management device 10 is connected to a server of the device vender 200 (FIG. 2) and a server of the part vender 300 (FIG. 2) through, for example, the network 5, for acquiring a part change notification, etc. In addition, the part information management device 10 acquires the market data 600 (FIG. 2) regarding parts from a server of a market research firm (not shown) through, for example, the network 5.

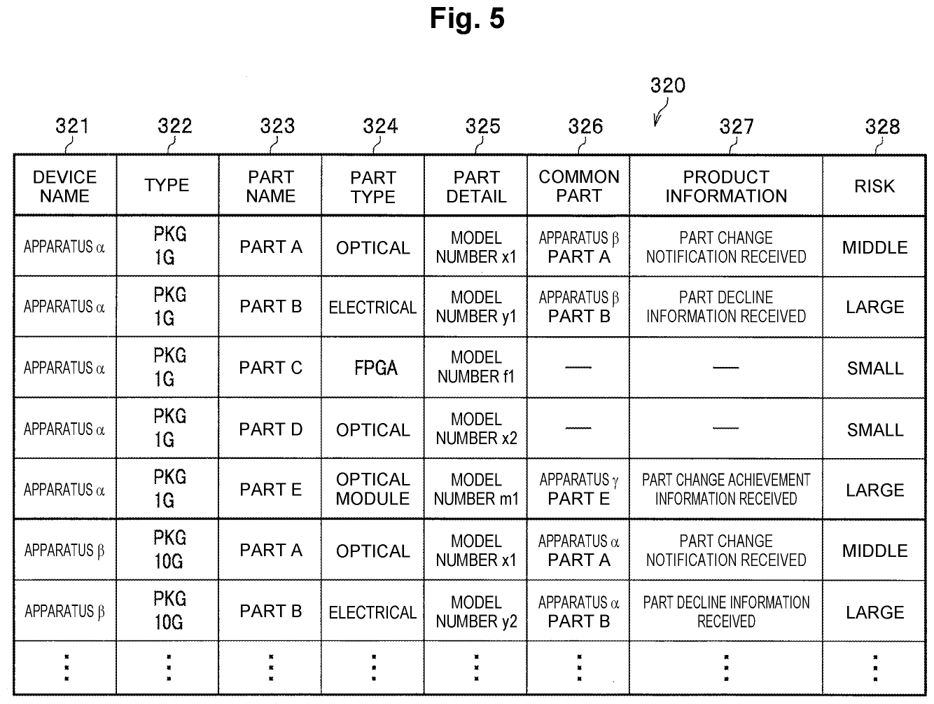

The part information management device 10 manages information regarding parts of the apparatuses 30 (hereinafter, referred to as “part information” and see FIG. 5 described later for details). The part information management device 10 is installed by, for example, the communications carrier 100 (FIG. 2) of the network 5 to which the apparatuses 30 are connected.

Part information 320 (FIG. 5) regarding the parts of the apparatuses 30 is stored in the part information database 20. In the part information 320 according to the present embodiment, information indicating that each part is associated as the same part or a similar part (later-described information regarding “common parts”) and “product information” including product decline information acquired from the market, etc. are stored in addition to types, model numbers, etc. of the parts. Further, in the part information database 20, risk information of a silent change estimated for each part by the part information management device 10 is stored.

The apparatuses 30 are each, for example, a network device connected to a network provided by a communications carrier. FIG. 3 shows the plurality of apparatuses 30 (an apparatus α, an apparatus β, and an apparatus γ); however, the number of the apparatuses is not limited to three but only has to be one or more.

A package 31 is installed in each of the apparatuses 30 and the package 31 includes a plurality of parts 32.

<<Part Information Management Device>>

FIG. 4 is a functional block diagram showing a configuration of the part information management device 10 according to the present embodiment.

As shown in FIG. 4, the part information management device 10 is implemented by a computer including a control unit 11, an input/output unit 12, and a storage unit 13.

The input/output unit 12 includes a communication interface for sending/receiving information, an input device such as a touch panel or a keyboard, and an input/output interface for sending/receiving information to/from an output device such as a monitor.

The storage unit 13 (a storage device) includes a flash memory, a hard disk, a RAM (Random Access Memory), or the like. It should be noted that although the storage unit 13 may be externally provided as a device independent of the part information management device 10 to serve as a recording device (a database device) that stores the part information database 20 as shown in FIG. 3, description will be made below with the assumption that the part information database 20, which stores the part information 320, is provided in the storage unit 13.

It should be noted that the storage unit 13 may store history information 330 shown in FIG. 4. The history information 330 will be described later.

FIG. 5 shows a data configuration example of the part information 320 according to the present embodiment. The part information 320 stores detailed information regarding the parts used in the apparatuses 30 and the risk information of a silent change estimated by a later-described risk estimation unit 114.

As shown in FIG. 5, the part information 320 stores information regarding items of a device name 321, a type 322, a part name 323, a part type 324, a part detail 325, a common part 326, product information 327, and a risk 328.

The device name 321 is a name of the network device and, for example, the “apparatus α” is stored. It should be noted that, for example, the “apparatus α”, which is the device name, is identified, thereby causing a device vender of the apparatus α to be identified.

The type 322 indicates a type of the package (PKG) 31 (FIG. 3) installed in the apparatus 30. For example, “PKG 1G” is stored for a 1G package and “PKG 10G” is stored for a 10G package.

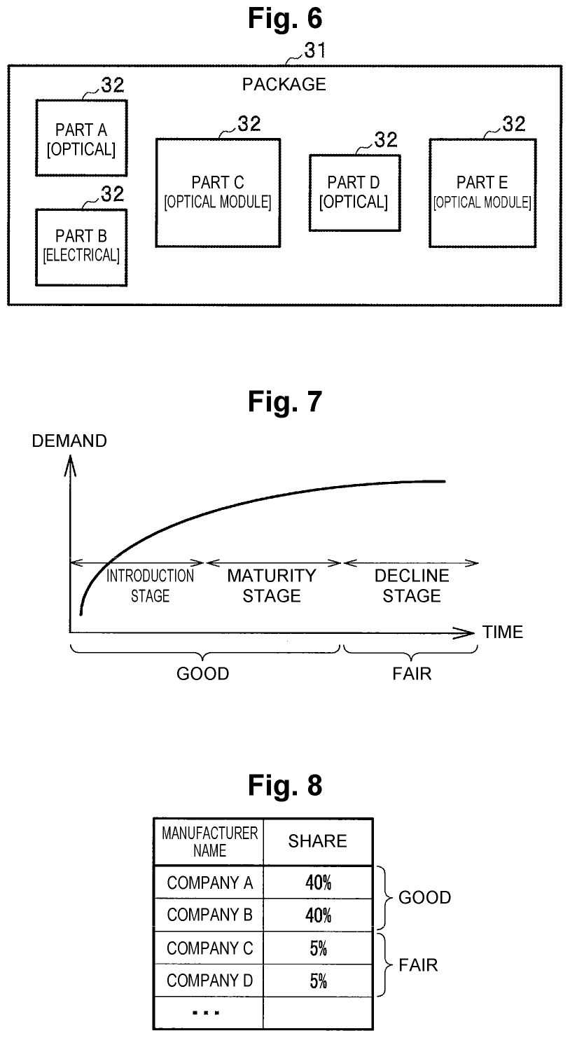

The part name 323 indicates the part name of each of the parts 32 (FIG. 3) of the package 31. Here, as shown as an example in FIG. 6, the description is made with the assumption that one package 31 includes five of the parts 32 (a part A, a part B, a part C, a part D, and a part E).

The part type 324 indicates the types of the parts. For example, the parts A and D are each an “optical” part, the part B is an “electrical” part, the part C is an “FPGA”, and the part E is an “optical module”.

In the part detail 325, a model number, a version, etc. of each of the parts are stored.

The common part 326 is information for associating the same or similar parts to each other. For example, the parts that are the same in all of part name, part type, and model number in the part detail are registered as the same parts (common parts). In addition, the parts that are the same in part name and part type but different in model number are registered as similar parts (common parts). It should be noted that the same or similar parts are collectively referred to as “common parts” in the present embodiment. Predetermined criteria for determination of whether or not the parts are similar are set in advance by a manager of the system. In the common part 326, identification information regarding the parts (common parts) determined to be the same or similar is stored. For example, in a field of the common part 326 for the part A of the apparatus α, which is the same part (the same in part name, part type, and model number) as the part A of the apparatus β, information “apparatus β part A” is stored as a common part. Further, in a field of the common part 326 for the part B of the apparatus α, which is a similar part (the same in part name and part type but different in model number) to the part B of the apparatus β, information “apparatus β part B” is stored as a common part.

It should be noted that any part with “—” in a field of the common part 326 has no same or similar part (common part).

The product information 327 stores, regarding the part 32, a part change notification from the device vender 200 (FIG. 2) or the like, if any, and part decline information acquired from the market data 600, if any. In addition, when information indicating achievement of performing a silent change in any other common part (part change achievement information) is acquired from a management server (not shown) of the network or the like via the input/output unit 12 and when a later-described failure cause analysis unit 115 detects a failure resulting from a silent change, the part change achievement information is stored in fields of the product information 327 for a faulty part and the common part thereof.

In the risk 328, risk information of a silent change estimated by the later-described risk estimation unit 114 is stored. Details on an estimation method of the risk information will be described later.

Referring back to FIG. 4, the control unit 11 includes a part setting information acquirement unit 111, a market data acquirement unit 112, a part information generation unit 113, the risk estimation unit 114, and the failure cause analysis unit 115.

When a new apparatus 30 (a network device) is introduced, the part setting information acquirement unit 111 acquires the part setting information 500 (FIG. 2) regarding the parts related to the device from the device vender 200 (FIG. 2) thereof or the like. The part setting information 500 includes various information for identifying the parts, such as device name, type, part name, part type, and part detail, which are to be stored in the part information 320 (FIG. 5).

The market data acquirement unit 112 acquires, from a server of a group (a market research firm) that performs market research for a target part, or the like, information regarding a shipment volume (demand), a share in the market, part decline information, etc. of the article. These pieces of market data are designated in advance as data related to a part change by a manager or the like. It should be noted that instead of the method where the market data is acquired from the server of the group that performs market research, or the like, the data may be inputted by the manager.

The part information generation unit 113 stores the part setting information 500 acquired by the part setting information acquirement unit 111 in relevant items in the part information 320 in the storage unit 13.

In addition, with use of the stored information such as part name, part type, and part detail, the part information generation unit 113 searches for whether or not any common part that can be recognized to be the same or similar part exists on the basis of the predetermined criteria for determination and, if a common part is found, stores the identification information regarding the part in a field of the common part 326 in the part information 320. It should be noted that the part information generation unit 113 may externally acquire information regarding a common part corresponding each of the parts via the input/output unit 12 and store the information in a field of the common part 326 in the part information 320.

When a part change notification or part decline information is acquired from the device vender 200 (FIG. 2) or the like, the part information generation unit 113 stores the information in the product information 327 in the part information 320.

In addition, when information indicating achievement of performing a silent change is externally acquired or when the later-described failure cause analysis unit 115 detects a failure resulting from the silent change, the part information generation unit 113 searches for whether or not any common part that is the same as or similar to a part in which the silent change is performed is registered in the part information 320 (FIG. 5) and, if any, stores the part change achievement information in a field of the product information 327 for the part.

The risk estimation unit 114 estimates a risk of a silent change of each part by using the market data 600 (FIG. 2), etc.

The risk estimation unit 114 estimates the risk on the basis of a predetermined estimation algorithm with use of, as the market data 600, (1) a market maturity, (2) a share in the market, and (3) the product information.

The risk estimation unit 114 determines, on the basis of the market data 600 indicating past sales, current sales, and sales forecast for the future of the part, a maturity of the part in the market as shown in FIG. 7. For example, it is determined which stage the part is in, an “introduction stage”, a “maturity stage”, or a “decline stage”. If determining that the current time is in the “introduction stage” and the “maturity stage”, the risk estimation unit 114 evaluates the part as “Good” (no possibility of part decline). In contrast, if determining the current time is in the “decline stage”, the risk estimation unit 114 evaluates the part as “Fair” (attention to part decline is necessary).

It should be noted that the evaluation based on the market data 600 may be automatically performed with an evaluation logic corresponding to each evaluation item (here, the “market maturity”) set as a program or the market data 600 may be displayed on a screen via the input/output unit 12 so that input of an evaluation result is received from a manager, being used for an estimation process of a risk.

In addition, on the basis of the information indicating a share of each part in the market as shown in FIG. 8, the risk estimation unit 114 evaluates a part having a share exceeding a predetermined threshold (for example, share 30%) as “Good” as the part accounts for a large market share and evaluates a part having a share equal to or less than the predetermined threshold as “Fair” as the part accounts for a small market share.

In addition, with reference to the part information database 20, the risk estimation unit 114 evaluates a part as “Insufficient” (a part change is highly possible) if part decline information exists as the product information 327 regarding the part. Further, the risk estimation unit 114 evaluates a part as “Insufficient” if achievement of a silent change (the part change achievement information) in any other device or any other package is found.

The risk estimation unit 114 estimates, on the basis of (1) the market maturity, (2) the share in the market, and (3) the evaluation result of the product information, a risk of a silent change by the predetermined estimation algorithm. According to the predetermined estimation algorithm, for example, the risk is “small” if none of “Fair” and “Insufficient” is given, the risk is “middle” if at least one “Fair” is given, and the risk is “large” if at least one “Insufficient” is given.

The evaluations of (1) the market maturity, (2) the share in the market, and (3) the product information used by the risk estimation unit 114 are not necessarily performed on the basis of three levels of “Good”, “Fair”, and “Insufficient”, but may be performed on the basis of four or more levels with an estimation algorithm according thereto provided. Further, the evaluations may be represented by numerical values. For example, with the assumption that “Good” is “1”, “Fair” is “2”, and “Insufficient” is “3”, an estimation algorithm may be provided where: the risk is “small” if a calculated total of all the evaluation items is less than a first predetermined value; the risk is “middle” if the total is at least the first predetermined value and less than a second predetermined value; and the risk is “large” if the total is equal to or more than the second predetermined value.

Further, the risk estimation unit 114 causes the storage unit 13 to store, for each device vender 200 (FIG. 2) or for each part type of part, a change history of the part, occurrence frequency of the part decline information, etc. as the history information 330 (see FIG. 4). The risk estimation unit 114 then calculates a part cycle on the basis of the history information 330, evaluating the part as “Good” if a predetermine period of time or more is left before a next change time for the part, “Fair” if a period of time less than the predetermined period of time is left before the next change time, and “Insufficient” if the current time is past the next change time. An estimation algorithm that estimates a risk of a silent change on the basis of this evaluation result in addition to the above-described evaluation result using the market data 600 may be provided.

The risk estimation unit 114 stores, via the part information generation unit 113, the evaluation of the risk of the silent change (risk information) estimated on the basis of the predetermined estimation algorithm in the item of the risk 328 in the part information 320 (FIG. 5).

Referring back to FIG. 4, in a case where failure information regarding the apparatus 30 is externally acquired, the failure cause analysis unit 115 searches for, among the parts of the apparatus 30, the part having a risk of a silent change equal to or higher than a predetermined level with reference to the part information database 20. Specifically, the failure cause analysis unit 115 extracts, among the parts of the apparatus 30 in which a failure occurs, the part having a “large” risk as a possible faulty part by searching the item of the risk 328 in the part information 320 (FIG. 5).

The failure cause analysis unit 115 then determines whether or not a part change of the extracted possible faulty part is actually performed by an existing silent change detection method or the like. It should be noted that examples of the existing silent change detection method include “Minato, Yuji [and five others], ‘Nettowaku Souchi no Kosyokanri Houhou no Teian (1) (Suggestion on Failure Management Method for Network Device (1))’, The Institute of Electronics, Information and Communication Engineers Society Conference, 2018, B-6-59, Tsushin Koen Ronbunshu 2 (Communication Lecture Papers 2), p. 59”. The failure cause analysis unit 115 can thus isolate whether or not the possible faulty part has a failure based on a silent change to perform cause analysis.

If determining that the cause of the part failure is based on a silent change, the failure cause analysis unit 115 outputs information to that effect (the part change achievement information) to the part information generation unit 113. The part information generation unit 113 then lists, in a field of the product information 327 for the part determined to have the failure in the part information 320, information to the effect that a failure resulting from a silent change has occurred as the part change achievement information and, if any common part is associated with the part, lists the part information achievement information also in a field of the product information 327 for the common part.

<Flow of Process>

Next, description will be made on a flow of a process to be performed by the part information management device 10.

(Estimation Process of Risk of Silent Change)

First, description will be made on a process of estimating, when a new apparatus 30 (FIG. 3) is connected to the part information management device 10, the risk of the silent change of the parts 32 of the apparatus 30.

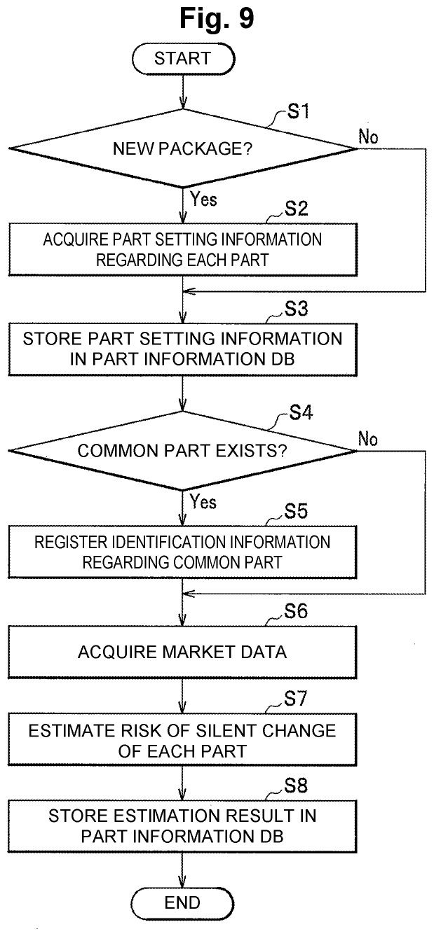

FIG. 9 is a flowchart showing a flow of an estimation process of a risk of a silent change to be performed by the part information management device 10 according to the present embodiment.

First, when a new apparatus 30 is connected, the part setting information acquirement unit 111 of the part information management device 10 acquires, from the apparatus 30, the type of the package 31 installed in the apparatus 30. The part setting information acquirement unit 111 then determines whether the acquired package 31 is a new package 31 or a package 31 already registered in the part information database 20 (step S1).

Here, if the part setting information acquirement unit 111 determines that the package 31 is not the new package 31 but the package 31 already registered in the part information database 20 (step S1→No), the process proceeds to next step S3.

In contrast, if the part setting information acquirement unit 111 determines that the package 31 is the new package 31 (step S1→Yes), the process proceeds to next step S2.

In step S2, the part setting information acquirement unit 111 acquires, from the device vender 200 (FIG. 2) of the apparatus 30 or the like, the part setting information 500 (FIG. 2) regarding the parts 32 of the package 31. The part setting information includes information regarding each of device name, type, part name, part type, and part detail.

Subsequently, in step S3, the part information generation unit 113 stores the part setting information 500 regarding the apparatus 30 in the part information database 20. Specifically, if the package 31 is determined to be the new package 31 in step S1, the part information generation unit 113 registers the part setting information 500 acquired in step S2 in each of relevant items in the part information 320 as a record for the new apparatus 30.

In contrast, if the package 31 is determined not to be the new package 31 in step S1, the part information generation unit 113 copies the part setting information 500 regarding the existing apparatus 30(package) stored in the part information 320 and registers it as a record for the new apparatus 30.

Next, with use of the stored information such as part name, part type, and part detail, the part information generation unit 113 of the part information management device 10 determines whether or not there is a common part recognized as the same or similar part on the basis of the predetermined criteria for determination (step S4).

If there is no common part (step S4→No), the part information generation unit 113 proceeds to next step S6.

In contrast, if there is a common part (step S4→Yes), the part information generation unit 113 registers, in a field of the common part 326 for the part, identification information regarding the same or similar part found as the common part (step S5).

Subsequently, the market data acquirement unit 112 of the part information management device 10 acquires the market data 600 (FIG. 2) regarding the parts stored in the part information database 20 from, for example, the server of the market research firm or the like (step S6). The market data 600 includes (1) sales related to a market maturity, (2) a share of the part in the market, and (3) product information such as part decline information.

Next, the risk estimation unit 114 of the part information management device 10 estimates a risk of a silent change of each part by the predetermined estimation algorithm with use of evaluation of the market data 600 such as evaluation of (1) a market maturity, (2) a share in the market, and (3) product information (step S7).

The risk estimation unit 114 then stores, for example, risk “large”, “middle”, or “small” as an estimation result of the silent change risk (risk information) of each part in the part information database 20 via the part information generation unit 113 (step S8).

It should be noted that the part information management device 10 repeatedly performs steps S6 to S8, i.e., from the acquirement of the market data 600 to the estimation process of a silent change and the registration (update) of a result thereof, at predetermined time intervals.

(Failure Isolation Process)

Next, description will be made on a failure isolation process regarding a silent change to be performed when a failure occurs.

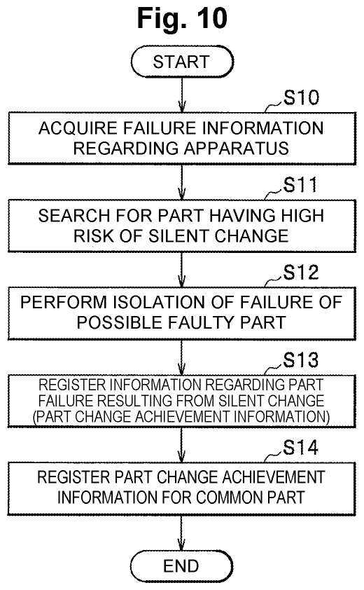

FIG. 10 is a flowchart showing a flow of an isolation process of a failure resulting from a silent change to be performed by the part information management device 10 according to the present embodiment.

First, the failure cause analysis unit 115 of the part information management device 10 acquires failure information regarding the apparatus 30 from a network apparatus management device or the like not shown (step S10). The failure information includes the identification information regarding the apparatus 30 in which the failure occurs.

Next, with reference to the part information database 20, the failure cause analysis unit 115 searches for, among the parts 32 of the apparatus 30, the part 32 having a risk of a silent change equal to or higher than the predetermined level (step S11).

Specifically, the failure cause analysis unit 115 searches the item of the risk 328 in the part information 320 (FIG. 5) and extracts, as a possible faulty part, the part the risk of which is “large” or, in some settings, the part the risk of which is “middle” among the parts 32 of the apparatus 30 in which the failure occurs.

Subsequently, the failure cause analysis unit 115 determines whether or not a part change has actually been performed in the extracted possible faulty part by, for example, the existing silent change detection method, thereby isolating whether or not the possible faulty part has a failure based on a silent change to perform cause analysis (step S12).

Then, if determining that the part failure is based on a silent change (a part change), the failure cause analysis unit 115 registers information to that effect (the part change achievement information) in a field of the product information 327 for the part in the part information database 20 via the part information generation unit 113 (step S13).

Next, the part information generation unit 113 searches for whether or not any common part is associated with the part in which the failure based on the silent change occurs. If a common part is associated, the part change achievement information, which indicates that the silent change has been performed, is also registered in a field of the product information 327 for the common part (step S14).

The part information management device 10 according to the present embodiment can thus estimate a risk of a silent change in advance and isolate, when a failure occurs in a device, whether or not the failure is a problem resulting from a silent change.

<Hardware Configuration>

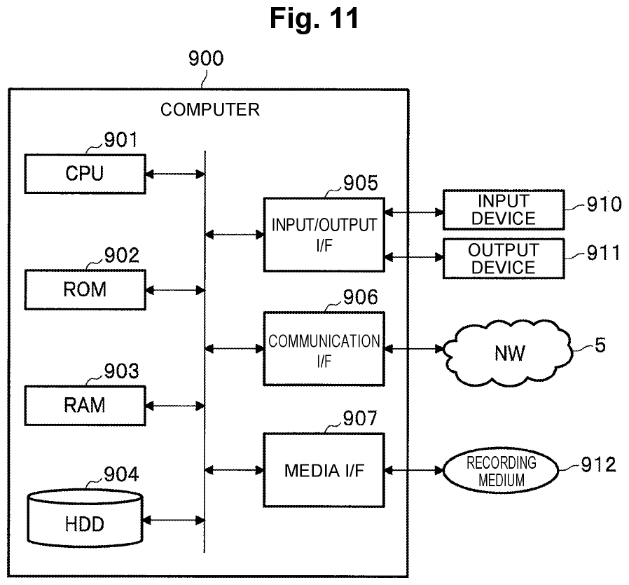

The part information management device 10 according to the present embodiment is implemented by a computer 900 having, for example, a configuration as shown in FIG. 11.

FIG. 11 is a hardware configuration diagram showing an example of the computer 900 that implements a function of the part information management device 10. The computer 900 includes a CPU (Central Processing Unit) 901, a ROM (Read Only Memory) 902, a RAM (Random Access Memory) 903, an HDD (Hard Disk Drive) 904, an input/output I/F (Interface) 905, a communication I/F 906, and a media I/F 907.

The CPU 901 operates in accordance with a program stored in the ROM 902 or the HDD 904, performing a control by the control unit 11 in FIG. 4. The ROM 902 stores a boot program that is to be executed by the CPU 901 when the computer 900 is started, a program related to hardware of the computer 900, and the like.

The CPU 901 controls an input device 910 such as a mouse or a keyboard and an output device 911 such as a printer or a display via the input/output I/F 905. The CPU 901 acquires data from the input device 910 and outputs generated data to the output device 911 via the input/output I/F 905.

The HDD 904 stores the program to be executed by the CPU 901, data to be used by the program, etc. The communication I/F 906 receives data from another device not shown and outputs the data to the CPU 901 through a communication network (e.g., the network 5) and, further, transmits data generated by the CPU 901 to another device through the communication network.

The media I/F 907 reads a program or data stored in a recording medium 912 and outputs it to the CPU 901 via the RAM 903. The CPU 901 loads a program related to a target process onto the RAM 903 from the recording medium 912 via the media I/F 907 and executes the loaded program. The recording medium 912 is an optical recording medium such as a DVD (Digital Versatile Disc) or a PD (Phase change rewritable Disk), a magnetooptical recording medium such as an MO (Magneto Optical disk), a magnetic recording medium, a conductor memory tape medium, a semiconductor memory, or the like.

For example, in a case where the computer 900 functions as the part information management device 10 according to the embodiment, the CPU 901 of the computer 900 executes the program loaded on the RAM 903, thereby implementing the function of the part information management device 10. Further, data in the RAM 903 is stored in the HDD 904. The CPU 901 reads the program related to a target process from the recording medium 912 and executes the program. Alternatively, the CPU 901 may read the program related to the target process from another device through a communication network (the network 5).

### Effects

The part information management device 10 according to the present embodiment includes: the part setting information acquirement unit 111 that acquires, as the part setting information 500, information for identifying the parts 32 set in the apparatuses 30; the market data acquirement unit 112 that acquires, for each of the parts 32, the market data 600 related to a part change of the part 32; the risk estimation unit 114 that estimates a risk of a silent change, which indicates that the part 32 is changed, by the predetermined estimation algorithm with use of the market data 600; and the part information generation unit 113 that generates the part information 320 with the acquired part setting information 500 for each of the parts 32 and the estimated risk of the silent change corresponding to each other and stores the part information 320 in the storage unit 13.

This allows the part information management device 10 to estimate a risk of a silent change in advance with use of the market data 600 related to a part change.

In the part information management device 10 according to the present embodiment, the market data 600 is information including the market maturity, the share in the market, and the product information including the part decline information of each of the parts 32 and the predetermined estimation algorithm estimates the risk of the silent change on the basis of information that evaluates each of a degree of a maturity of the market based on the market maturity regarding the part, a smallness of the share in the market regarding the part, and presence/absence of the part decline information regarding the part.

By virtue of using, as the market data 600, the market maturity, the share in the market, and the product information including the part decline information as described above, the part information management device 10 can estimate the silent change risk with a higher accuracy.

In the part information management device 10 according to the present embodiment, the storage unit 13 stores, for each of the parts 32, the change history and the occurrence frequency of the part decline information of the part 32 as the history information 330, and the risk estimation unit 114 calculates a part cycle with use of the history information 330 and estimates the risk of the silent change by the predetermined estimation algorithm including information that evaluates a length of a period of time to elapse before the next change time for the part.

By virtue of calculating the part cycle with use of the history information 330, that is, the change history of the part 32 and the occurrence frequency of the part decline information as described above, the part information management device 10 can estimate the silent change risk with a higher accuracy.

In the part information management device 10 according to the present embodiment, the part information generation unit 113: registers, in the part information 320, information that associates each of the same part and a part determined to be similar in accordance with the predetermined criteria for determination as a common part on the basis of the part setting information 500 regarding each of the parts 32; registers, when acquiring a part change notification indicating that the part 32 of one of the apparatuses 30 is changed, the part change notification in the part information 320 in association with the changed part; and registers, if the changed part 32 has the common part, the part change notification in the part information 320 in association with the common part, and the risk estimation unit 114 estimates the risk of the silent change by the predetermined estimation algorithm including information that evaluates the acquirement of the part change notification.

By virtue of registering the same part and the similar part as common parts in the part information 320 as described above, in a case where a part change notification regarding one of the parts 32 is acquired, even when this part 32 is used in another apparatus 30 the device vender 200 of which is different, the part information management device 10 can estimate a silent change risk with information to the effect that the part change notification regarding the part 32 is acquired reflected. Therefore, the part information management device 10 can estimate the risk of the silent change with a higher accuracy.

The part information management device 10 according to the present embodiment further includes the failure cause analysis unit 115 that: acquires failure information including identification information regarding one of the apparatuses 30 that has a failure; extracts the estimated risk of the silent change of each of the parts 32 of the apparatus 30 that has the failure with reference to the part information 320; extracts, if the extracted risk is equal to or higher than a predetermined level, relevant one of the parts as a possible faulty part as the silent change is highly likely to be performed; and performs the failure cause analysis of the extracted possible faulty part to isolate whether or not the failure results from the silent change.

The part information management device 10 can promptly isolate whether or not the failure of the apparatus results from the silent change in the above manner. The part information management device 10 thus enables reducing an influence of the failure on a service.

In the part information management device 10 according to the present embodiment, the part information generation unit 113: registers, in the part information 320, information that associates each of the same part and a part determined to be similar in accordance with the predetermined criteria for determination as the common part on the basis of the part setting information 500 regarding each of the parts 32; registers, if the failure cause analysis unit 115 determines that the failure results from the silent change, the part change achievement information indicating achievement of performing the silent change in the part information 320 in association with the relevant part determined to have the failure; and registers, if the relevant part 32 determined to have the failure has the common part, the part change achievement information in association with the common part, and the risk estimation unit 114 estimates the risk of the silent change by the predetermined estimation algorithm including information that evaluates presence/absence of the part change achievement information.

By virtue of registering the same part and the similar part as common parts in the part information 320 as described above, the part information management device 10 can also estimate a silent change risk of the common part corresponding to the part 32 determined to have the failure resulting from the silent change with achievement of performing the silent change taken into consideration. Therefore, the part information management device 10 can estimate the risk of the silent change with a higher accuracy.

### REFERENCE SIGNS LIST

1 Part information management system
10 Part information management device
11 Control unit
12 Input/output unit
13 Storage unit (storage device)
20 Part information database (DB)
30 Apparatus
31 Package
32 Part
100 Communications carrier
111 Part setting information acquirement unit
112 Market data acquirement unit
113 Part information generation unit
114 Risk estimation unit
115 Failure cause analysis unit
200 Device vender
300 Part vender
320 Part information
330 History information
500 Part setting information
600 Market data

1. A part information management device comprising:
a part setting information acquirement unit that includes one or more processors and that is configured to acquire, as part setting information, information for identifying one or more parts in apparatuses;
a market data acquirement unit that includes one or more processors and that is configured to acquire, for each of the one or more parts, market data related to a change of the each part;
a risk estimation unit that includes one or more processors and that is configured to estimate a risk of a silent change by a predetermined estimation algorithm with use of the market data, the risk of the silent change indicating that the part is changed; and
a part information generation unit that includes one or more processors and that is configured to generate part information with the part setting information acquired for each of the one or more parts and the estimated risk of the silent change corresponding to each other and store the part information in a storage unit.

2. The part information management device according to claim 1, wherein:
the market data is information including a market maturity, a share in a market, and product information including part decline information of each of the one or more parts, and
the predetermined estimation algorithm estimates the risk of the silent change on a basis of information that evaluates each of a degree of a maturity of the market based on the market maturity regarding the part, a smallness of the share in the market regarding the part, and presence/absence of the part decline information regarding the part.

3. The part information management device according to claim 2, wherein:
the storage unit stores, for each of the one or more parts, a change history and an occurrence frequency of the part decline information of the part as history information, and
the risk estimation unit calculates a part cycle with use of the history information and estimates the risk of the silent change by the predetermined estimation algorithm including information that evaluates a length of a period of time to elapse before a next change time for the part.

4. The part information management device according to claim 1, wherein:
the part information generation unit:
registers, in the part information, information that associates each of a same part and a part determined to be similar in accordance with predetermined criteria for determination as a common part on a basis of the part setting information regarding each of the parts;
registers, based on acquiring a part change notification indicating that the part of one of the apparatuses being changed, the part change notification in the part information in association with the changed part; and
registers, if the changed part has the common part, the part change notification in the part information in association with the common part, and
the risk estimation unit estimates the risk of the silent change by the predetermined estimation algorithm including information that evaluates acquirement of the part change notification.

5. The part information management device according to claim 1, further comprising:
a failure cause analysis unit that:
acquires failure information including identification information regarding one of the apparatuses that has a failure;
extracts the estimated risk of the silent change of each of the parts of the apparatus that has the failure with reference to the part information;
extracts, if the extracted risk is equal to or higher than a predetermined level, one of the parts as a faulty part based on a probability of the silent change being performed; and
performs a failure cause analysis of the extracted faulty part to isolate whether or not the failure results from the silent change.

6. The part information management device according to claim 5, wherein:
the part information generation unit:
registers, in the part information, information that associates each of a same part and a part determined to be similar in accordance with predetermined criteria for determination as a common part on a basis of the part setting information regarding each of the parts;
registers, if the failure cause analysis unit determines that the failure results from the silent change, part change achievement information indicating achievement of performing the silent change in the part information in association with the part determined to have the failure; and
registers, if the part determined to have the failure has the common part, the part change achievement information in association with the common part, and
the risk estimation unit estimates the risk of the silent change by the predetermined estimation algorithm including information that evaluates presence/absence of the part change achievement information.

7. A part information management method for a part information management device that manages information regarding one or more parts of apparatuses, the part information management method comprising:
acquiring, as part setting information, information for identifying the one or more parts in the apparatuses;
acquiring, for each of the one or more parts, market data related to a part change of the each part;
estimating a risk of a silent change by a predetermined estimation algorithm with use of the market data, the risk of the silent change indicating that the part is changed; and
generating part information with the part setting information acquired for each of the one or more parts and the estimated risk of the silent change corresponding to each other and storing the part information in a storage unit.

8. A non-transitory recording medium storing a part information management program that, upon execution, causes a computer to perform operations comprising:
acquiring, as part setting information, information for identifying one or more parts in apparatuses;
acquiring, for each of the one or more parts, market data related to a part change of the each part;
estimating a risk of a silent change by a predetermined estimation algorithm with use of the market data, the risk of the silent change indicating that the part is changed; and
generating part information with the part setting information acquired for each of the one or more parts and the estimated risk of the silent change corresponding to each other and storing the part information in a storage device.

9. The non-transitory recording medium according to claim 8,
wherein the market data is information including a market maturity, a share in a market, and product information including part decline information of each of the one or more parts, and
wherein the operations further comprise estimating the risk of the silent change on a basis of information that evaluates each of a degree of a maturity of the market based on the market maturity regarding the part, a smallness of the share in the market regarding the part, and presence/absence of the part decline information regarding the part.

10. The non-transitory recording medium according to claim 9, wherein the operations further comprise:
storing, for each of the one or more parts, a change history and an occurrence frequency of the part decline information of the part as history information; and
calculating a part cycle with use of the history information and estimating the risk of the silent change by the predetermined estimation algorithm including information that evaluates a length of a period of time to elapse before a next change time for the part.

11. The non-transitory recording medium according to claim 8, wherein the operations further comprise:
registering, in the part information, information that associates each of a same part and a part determined to be similar in accordance with predetermined criteria for determination as a common part on a basis of the part setting information regarding each of the parts;
registering, based on acquiring a part change notification indicating that the part of one of the apparatuses being changed, the part change notification in the part information in association with the changed part;
registering, if the changed part has the common part, the part change notification in the part information in association with the common part; and
estimating the risk of the silent change by the predetermined estimation algorithm including information that evaluates acquirement of the part change notification.

12. The non-transitory recording medium according to claim 8, wherein the operations further comprise:
acquiring failure information including identification information regarding one of the apparatuses that has a failure;
extracting the estimated risk of the silent change of each of the parts of the apparatus that has the failure with reference to the part information;
extracting, if the extracted risk is equal to or higher than a predetermined level, one of the parts as a faulty part based on a probability of the silent change being performed; and
performing a failure cause analysis of the extracted faulty part to isolate whether or not the failure results from the silent change.

13. The non-transitory recording medium according to claim 12, wherein the operations further comprise:
registering, in the part information, information that associates each of a same part and a part determined to be similar in accordance with predetermined criteria for determination as a common part on a basis of the part setting information regarding each of the parts;
registering, based on the failure resulting from the silent change, part change achievement information indicating achievement of performing the silent change in the part information in association with the part determined to have the failure;
registering, if the part determined to have the failure has the common part, the part change achievement information in association with the common part; and
estimating the risk of the silent change by the predetermined estimation algorithm including information that evaluates presence/absence of the part change achievement information.
